(19) United States
(12) Patent Application Publication
(10) Pub. No.: US 2003/0074114 A1
(43) Pub. Date: Apr. 17, 2003

(54) Watercraft information sharing system

(76) Inventors: Takashi Okuyama, Shizuoka (JP); Masahiko Kato, Shizuoka (JP)

Correspondence Address: KNOBBE MARTENS OLSON & BEAR LLP, 2040 MAIN STREET, FOURTEENTH FLOOR, IRVINE, CA, 92614, US

(21) Appl. No.: 10/264,301

(22) Filed: Oct. 2, 2002

(30) Foreign Application Priority Data
Oct. 2, 2001 (JP) 2001-306696

(51) Int. Cl. G01C 21/30

(52) U.S. Cl. 701/21; 701/211

(57) ABSTRACT

A watercraft information sharing system receives actual watercraft component performance information from participating watercraft and manages the received data at a server in order to provide the combined watercraft component information to registered users. The watercraft information sharing system provides a registered user, a dealer or a manufacturer with the actual performance data of specific combinations of watercraft components. This information allows the user to evaluate the performance of different combinations of watercraft components without having to physically operate watercraft having the combinations of components.

### PRIORITY INFORMATION

This application is based on and claims priority under 35 U.S.C. §119 to Japanese Patent Application No. 2001-306696, filed on Oct. 2, 2001, the entire contents of which are hereby expressly incorporated by reference herein.

### BACKGROUND OF THE INVENTION

1. Field of the Invention

This invention relates to a watercraft information sharing system for allowing watercraft component performance data to be accessed by approved users.

2. Description of the Related Art

Watercraft (e.g., personal watercraft or boats) typically incorporate internal combustion engines in combination with propulsion units to provide power to propel the watercraft in a variety of popular applications (e.g., skiing, fishing, sightseeing, and the like). For many types and brands of watercraft, the components that are available to be installed on the watercraft are manufactured by a number of different manufacturers, and a customer for a watercraft is able to choose components to be installed on the customer's watercraft from the available components. For example, the customer can select the hull design and select an engine and propulsion unit combination to be installed on the hull.

Watercraft with different hull designs and different engine and propulsion unit combinations have different performance characteristics. Because many different combinations of hull designs, engine designs, and propeller designs are available, a customer may find it challenging to select a combination that provides optimal performance for the customer's applications for the watercraft.

### SUMMARY OF THE INVENTION

Although watercraft manufacturers and watercraft dealers are aware of the performance of individual parts, it is difficult to evaluate the performance characteristics of each possible hull, engine, and propeller combination. Applicants have determined that it would be beneficial to offer a potential buyer accurate data showing true performance values of various watercraft component combinations. The watercraft information sharing system described herein is particularly well-suited for providing valuable watercraft component performance information to potential watercraft purchasers, watercraft manufacturers, watercraft sellers, and current watercraft operators.

An aspect of the present invention in accordance with a preferred embodiment of the present invention is a watercraft information sharing system that comprises a computer, a software program, and a method of providing performance information for selected combinations of watercrafts and watercraft components.

In one particular embodiment, the watercraft information sharing system comprises a data collecting system that collects product performance data from current watercraft customers who own and operate watercraft. The customers provide the watercraft information sharing system with information regarding the combinations of components installed on the watercraft and with information regarding the performance of the watercraft during actual operating conditions. The collected watercraft performance information is provided to various users via a communication network so that a potential customer for a watercraft with a particular combination of components can review the performance data of other watercraft having the same combination or a similar combination of components.

Another aspect of the present invention in accordance with another preferred embodiment is a watercraft information providing system. The information providing system comprises a plurality of sensors. Each sensor detects operational parameters of a component of the watercraft that may affect the performance of the watercraft as it is being operated. An data collection system on the watercraft collects and compiles the information detected by the sensors and stores the compiled information as performance data for the watercraft. An information terminal is coupled to the data collection system to selectively display the stored performance data to an operator of the watercraft. In addition, the information terminal is selectively coupled to the Internet or another communications network to transmit the stored performance data to a central location (e.g., a web site) where the performance data from multiple watercraft is received, compiled and made available to authorized users of the web site.

Another aspect of the present invention in accordance with another preferred embodiment is a computer that discloses information relating to a watercraft on a communications network. The computer is configured to receive information via a communications network relating to the parts incorporated in a watercraft of a customer and to receive information (e.g., performance data) regarding the performance of the watercraft under operating conditions. The computer is further configured to disclose the performance data to predetermined users via the communications network in response to inquiries for performance data for watercraft having selected combinations of parts.

Another aspect of the present invention in accordance with another preferred embodiment is a program that instructs a computer to manage information regarding watercraft on a communications network. The program instructs the computer to receive information via the communications network from a plurality of watercraft. The received information from each watercraft includes identification of parts incorporated in the watercraft and performance data of the watercraft obtained under actual operation of the watercraft. The program further instructs the computer to manage the information received from the plurality of watercraft and to selectively disclose the performance data to authorized users in response to inquiries for performance data for watercraft having selected combinations of components.

Another aspect of the present invention in accordance with another preferred embodiment is a method for operating a computer to disclose the information relating to watercraft on a communications network. The method comprises a step of receiving information relating to parts incorporated in a watercraft of a customer in association with performance data for the parts transmitted from the watercraft via the communications network. The method includes the further steps of managing the received parts information and performance data and selectively disclosing the managed information and performance data to authorized users in response to inquiries for performance information for watercraft having selected combinations of parts.

Another aspect of the present invention in accordance with another preferred embodiment is a method of providing information relating to watercraft performance via a computer. The method comprises a step of storing information relating to the parts incorporated in a watercraft of a customer and storing associated performance data for the parts transmitted from the watercraft of the customer via a communications network. The method includes a step of prompting an authorized user to input the information relating to the parts that the user wants to incorporate in a watercraft to be purchased. The method includes a step of using the information from the user to access a database of performance data for watercraft having the same or similar parts and to retrieve and display the applicable performance data.

Another aspect of the present invention in accordance with another preferred embodiment is a system in which dealers or boat builders obtain performance data for watercraft sold to customers, wherein the watercraft have combinations of components that affect the performance of the watercraft. The system manages the performance data and selectively discloses the performance data to authorized persons wanting to evaluate the performance data of similar watercraft having similar combinations of installed components.

### BRIEF DESCRIPTION OF THE DRAWINGS

The present invention will be described below in connection with the accompanying drawing figures in which:

FIG. 1 is a pictorial diagram of a watercraft information sharing system that include an exemplary watercraft with installed components and a performance data gathering system, a communications system, and a plurality of computer systems that receive, manage and selectively display the performance data from a plurality of watercraft;

FIG. 2 is a side elevational view of a watercraft, with the structure of the watercraft and power unit shown in phantom, and with a performance data gathering system illustrated by a block diagram;

FIG. 3 is a block diagram that illustrates a system for communicating between an engine control unit, sensors and a display terminal via a local area

FIG. 4 is a diagram that illustrates an example of a table of measured performance data;

FIG. 5 is a flowchart that illustrates the processing and storing of received performance data and providing updated performance data to sales sites;

FIG. 6 is a flowchart that illustrates a method for accessing stored performance data in response to user input and for displaying the selected performance data; and

FIG. 7 is a pictorial diagram that illustrates an exemplary menu displayed to a user to enable the user to enter data representing a selected combination of watercraft components and to enable the user to initiate access to the watercraft performance data for the selected combination of components.

### DETAILED DESCRIPTION OF THE PREFERRED EMBODIMENT

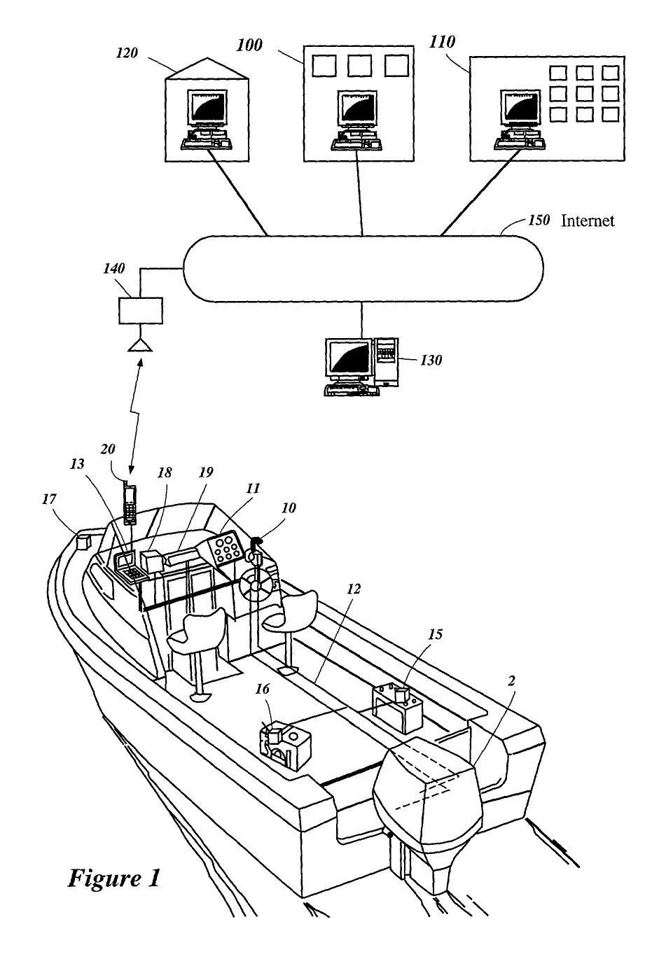

As shown in FIG. 1, a watercraft information sharing system comprises a computer 100 at a watercraft retail dealer. The dealer sells watercraft and parts for the watercraft to customers who typically are also watercraft users. Another computer 110 is installed at a watercraft manufacturer. The watercraft manufacturer assembles watercraft and parts to sell to a watercraft purchaser such as a dealer or a watercraft customer. A computer 120 is installed, for example, in the home or office of a potential watercraft customer who wants to purchase a watercraft. A computer information terminal 13 is installed on a watercraft already owned by a user. A server computer 130 manages performance data of watercraft in service (e.g., watercraft owned by users or by dealers). A communication network, such as, for example, the Internet 150, interconnects the computers through a communication means, such as, for example, a cellular phone 20 and a radio transceiver 140 in a cellular base station.

The watercraft includes a hull 1 and an outboard motor 2. The outboard motor 2 is mounted on the stem of the hull 1 and drives a propeller (not shown) or other propulsion unit to propel the hull 1. The hull 1 has a cockpit for a user. The cockpit is typically located remotely from the outboard motor 2 towards the bow the hull 2. The cockpit houses a control unit 10 that allows the outboard motor 2 to be controlled remotely by the user in the cockpit. A digital indicator 11 in the cockpit is adapted to display information received from an local area network (LAN) 12 installed on the watercraft. The LAN 12 is also coupled to the information terminal 13, to an active monitor 18 and to a radio transceiver (transmitter and receiver) 19. The active monitor 18 displays engine information, detection of fish, boat position information obtained via a GPS (Global Positioning System), and navigation status. The radio transceiver 19 advantageously utilizes VHF radio and satellite radio as a system of verbal and data communication, particularly in areas not serviced by a cellular telephone system.

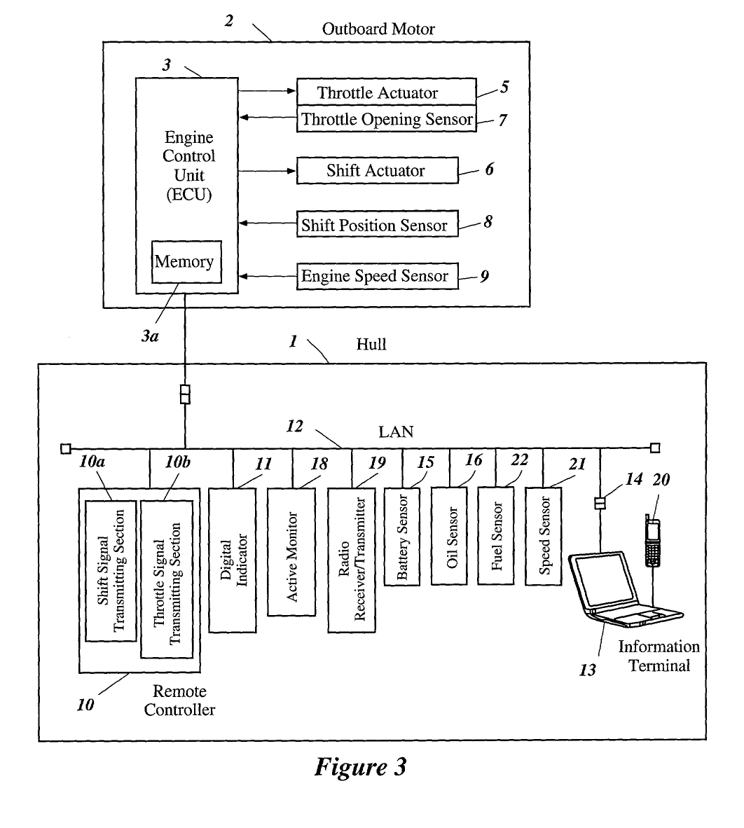

The control unit 10 is provided with operation levers, such as a shift lever and a throttle lever. The operator uses the throttle lever to input commands to the outboard motor 2 (e.g., commands to change the speed or the torque of the outboard motor 2). As shown in FIG. 3, the control unit 10 includes a shift signal transmitting section 10a that generates a digital signal representing shift operation information responsive to an operation of the shift lever by the operator. The control unit 10 also includes a throttle signal transmitting section 10b that generates a digital signal representing throttle operation information responsive to operation of the throttle lever by the operator. The digital signals generated by the signal transmitting sections 10a and 10b are transmitted via the LAN 12 to an ECU 3 of the outboard motor 2.

The digital indicator 11 digitally displays information received from corresponding sensors regarding boat speed, navigation distance, time, engine speed, time duration of engine operation, trim angle of the outboard motor 2, hydraulic pressure, fuel quantity, battery voltage, and various alarms.

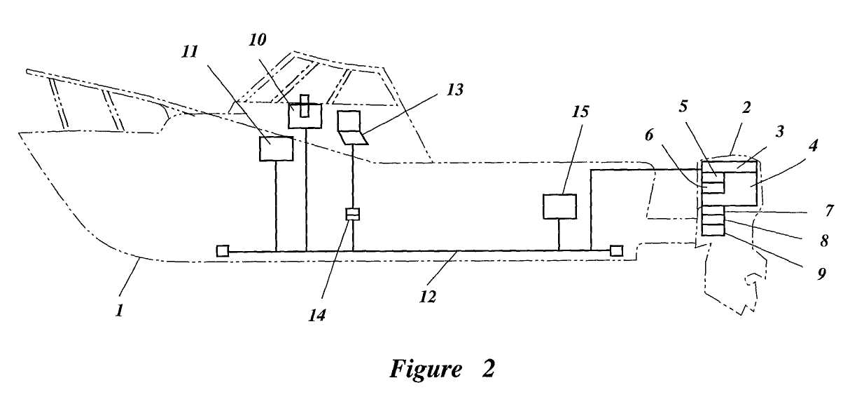

As further shown in FIGS. 2 and 3, the watercraft includes a battery sensor 15, an oil sensor 16, an obstacle sensor 17, a hull speed sensor 21 and a fuel sensor 22. The battery sensor 15 detects the capacity of a charge in a battery. The oil sensor 16 detects an amount of oil in the outboard motor 2. The obstacle sensor 17 detects obstacles that may be in front of the hull 1 as the boat is being operated. The hull speed sensor 21 detects the speed of the hull relative to the water. The fuel sensor 22 detects the amount of fuel remaining in at least one fuel container. In addition to the illustrated components, the watercraft advantageously includes an oil hose, a power cable from the battery, and a fuel hose.

The LAN 12 communicates between the watercraft equipment described above and the engine components within the outboard motor 2. A connector 14 provides a detachable connection between the LAN 12 and the information terminal 13. Preferably, the connector 14 provides one-touch operation for connecting and disconnecting the information terminal 13 and the LAN 12.

As shown in FIGS. 2 and 3, the outboard motor 2 is provided with an engine control unit 3 (ECU), an engine 4, and a throttle actuator 5. The throttle actuator 5 actuates a throttle valve (not shown) or other engine control device in the engine 4. A shift actuator 6 varies the shift position of a shifting mechanism in the outboard motor 2. A throttle position sensor 7 detects an amount of opening of the throttle valve. A shift sensor 8 detects the shift position. An engine speed sensor 9 detects the engine speed.

The engine 4 generates power that is selectively coupled to a propulsion device (not shown) to provide a propulsion force to propel the watercraft in a forward direction or a reverse direction. The ECU 3 is responsive to control inputs from the throttle signal transmitting section of the control unit 10 to generate control signals to the throttle actuator 5 to adjust the position of the throttle valve to manipulate the air/fuel mixture provided to combustion chambers in the engine 4. Ignition of the air/fuel mixture generates the engine output power delivered to the propulsion device. Specifically, the throttle signals generated by operating the throttle control 10 are transmitted to the, ECU 3 in the outboard motor 2 via the LAN 12. The ECU 3 control the throttle actuator 5 to vary the throttle opening and thus to manipulate the air/fuel mixture. The shift signals generated by operating the shift section of the control unit 10 are also transmitted to the ECU 3 in the outboard motor 2 via the LAN 12. The ECU 3 is responsive to the shift signals to control the shift actuator 6 to change the shift position (e.g., forward, reverse or neutral).

When the throttle position changes, the throttle position sensor 7 detects the actual position of the throttle valve and then sends the detected information to the ECU 3. The shift position sensor 8 detects the shift position, and the engine speed sensor 9 detects the engine speed. The sensors 8 and 9 send the detected information to the ECU 3.

The ECU 3 comprises specific digital hardware such as, for example, a microprocessor coupled to a memory 3a and to an interface for communicating with the LAN 12. The ECU 3 operates in response to a program (e.g., software). The ECU 3 and the information terminal 13 are referred to as a data collecting system.

The ECU 3 receives the detected signals from the throttle opening sensor 7, the shift position sensor 8, and the engine speed sensor 9. The ECU 3 receives other control signals such as the throttle signal and shift signal from the control unit 10. When the watercraft is operating at a cruising speed, the ECU 3 receives a watercraft speed signal from the hull speed sensor 21. The ECU 3 also receives an acceleration (impact) signal from an acceleration sensor (not shown) and a boat inclination signal from an attitude sensor (not shown).

The microprocessor in the ECU 3 processes the information received via the LAN 12 and process the detected signals received from the sensors. The program in the microprocessor of the ECU 3 causes the microprocessor to compile the processed signals and information as performance data and to store the compiled performance data in the memory 3a.

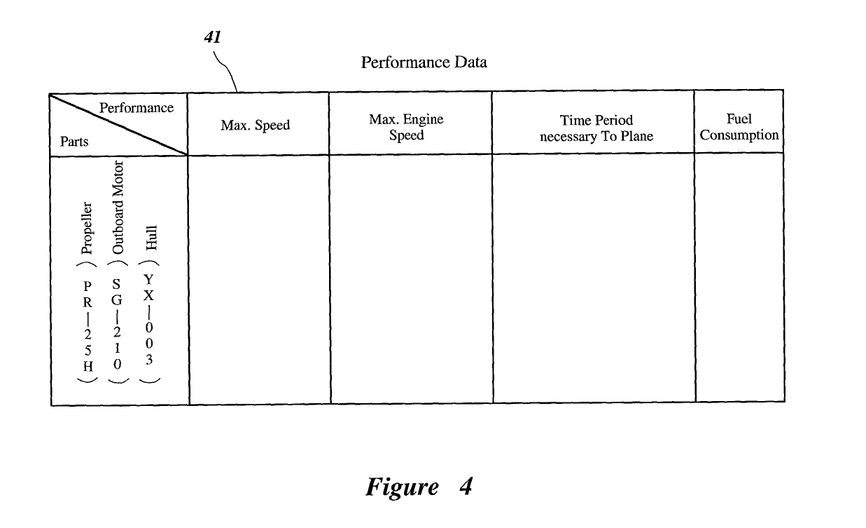

As illustrated in FIG. 4, the performance data 41 advantageously includes a maximum boat speed, a maximum engine speed, time (or distance) to achieve planing, and fuel consumption pertaining to a specific hull model, a specific outboard motor and a specific propeller. The model numbers pertaining to the individual parts are advantageously stored in the memory 3a.

The server 130 on the Internet 150 hosts a sales site that is structured to store and maintain data representing information for the user's (e.g., customer's) watercraft. The information includes, for example, the model numbers of the main parts associated with boat performance (e.g., the hull model, the outboard motor model, the propeller model, and the like). The stored information is available to users who want to inquire about specific watercraft part combinations.

In order to encourage watercraft users (e.g., customers) to provide performance data pertaining to their watercraft, customers who provide the data are given special benefits, which can include, for example, trade-in discounts and preferential warranties. The computer 100 at the dealer and the computer 110 at the boat builder are able to access the customer information to enable the dealer and the boat builder to determine whether a particular customer is entitled to receive any special benefits.

Each of the dealers, boat builders, boat manufacturers, rating agencies, and persons wanting to purchase boats contracts with the site operator to obtain a user ID and a password. The specific user ID and password allow the person or business entity to utilize the site to obtain specific boat information after the person or entity is authenticated as an authorized user by each computer 100, 110 and 120. A dealer or a boat builder can operate the server 130. Alternatively, different network stations, such as an application service provider (ASP), can operate the server 130.

When a user requests access to the sales site via any of the computers 100, 110, 120 having access to the server 130, a browser installed in the respective computer 100, 110, 120 is activated. The user replies to prompts on a screen provided by the browser to input the address of the sales site. Subsequently, the browser displays a user authentication screen with prompts for the user to enter the user ID and the password, which, if properly authenticated by the server 130, allow the user to enter the sale site.

The performance data 41 stored in the memory 3a of the ECU 3 in the watercraft is transmitted at selected times to the information terminal 13. Thereafter, the performance data 41 is transmitted from the information terminal 13 to the server 130 via the cellular phone 20 and the transceiver 140 in the cellular base station, via a land telephone line, or via another communications system. The selected time may be based on a time schedule stored in the information terminal 13. The time schedule may be based on criteria selected by the watercraft owner or criteria selected by the watercraft dealer or manufacturer to entitle the watercraft owner to the benefits discussed above.

The server 130 is advantageously programmed with watercraft performance managing software to receive and manage the performance data 41 transmitted from the customer watercraft. The server 130 is also advantageously programmed with web server software to control the sales site, as discussed above.

The watercraft performance managing software manages the performance data 41 as a database for the information of the main parts of the watercraft owned by the customer. For example, the database can contain information corresponding to model numbers of the hull, outboard motor and propeller, the maximum boat speed, the maximum engine speed, the time (or distance) needed to reach planing, and fuel consumption.

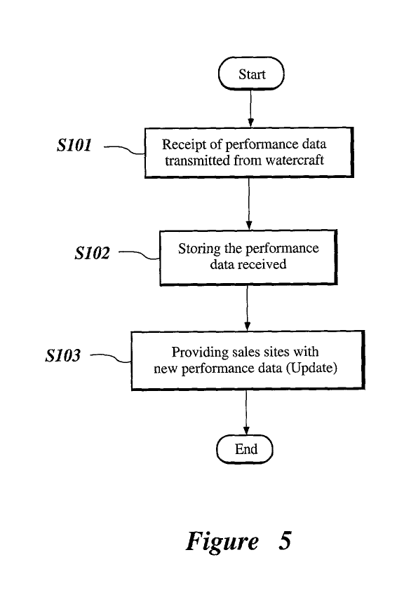

The operation of the watercraft information sharing system is described below in connection with FIGS. 5-7. In the watercraft information sharing system of this embodiment, if a watercraft is operated by a customer, the ECU 3 produces the performance data 41 based on the detected signals from respective sensors and stores this data in the memory 3a. The performance data 41 includes, for example, the maximum boat speed, the maximum engine speed, the time (or distance) to reach planing, and fuel consumption.

The maximum watercraft speed is the highest detected watercraft speed signal obtained by the hull speed sensor 21 during every operation of the watercraft and then stored in the memory 3a. The maximum engine speed is the highest engine speed signal obtained by the engine speed sensor 9 during every operation of the watercraft and then stored in memory 3a. The performance of the outboard motor(s) from rest (or from a low speed) to a planing speed or cruising speed is monitored and stored in memory 3a. A practical cruising time (i.e., how long of a time can the watercraft cruise) can be stored in memory 3a and can vary depending on information received from the watercraft speed sensor 21 and the fuel sensor 22. Fuel consumption is calculated based on the signal from the fuel sensor 22 and the speed sensor 21 in liters per hour or any other appropriate fuel consumption units. A practical cruising distance can be calculated by the ECU 3 by dividing the watercraft fuel amount by the watercraft fuel consumption. A practical cruising time can then be calculated by the ECU 3 by dividing the practical cruising distance by a watercraft speed and stored in memory 3a.

When a customer activates the application software of the information terminal 13 to collect specific watercraft information, the performance data 41 stored in the ECU 3 is read and displayed on the screen of the information terminal 13. Thus, the customer (e.g., the owner) of the watercraft is able to review the performance data for the customer's watercraft using the information terminal 13. In response to an upload instruction, the performance data 41 is transmitted to the server 130 via the cellular telephone 20 and the transceiver 140 in the cellular base station, via the Internet 150, or via another communications system.

FIG. 5 illustrates a processing routine performed at the server 130 by the watercraft performance managing software. In a first operation block S101, the performance data 41 is received from a watercraft. Then, in an operation block S102, the performance data 41 a participating customer is stored in the database with performance data 41 received for watercraft from other customers.

In an operation block S103 the watercraft performance managing software sequentially transmits the newly stored performance data 41 to the web server software, which adds the data to the web site or updates existing data at the sales site.

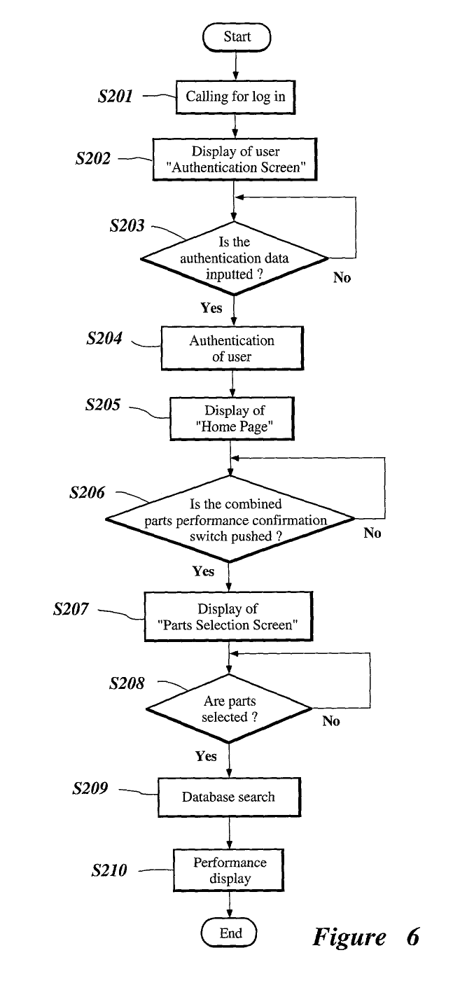

FIG. 6 illustrates a database search procedure. In a first operation block S201, a login screen is activated when a person wanting to purchase a watercraft activates the browser software on the computer 120 at the person's home or office. The user inputs login information using the browser to initiate access to the sales site. Then, in a second operation block S202, the web server software displays a user authentication screen or dialog box for entering the sales site. The authentication screen prompts the user to enter a user ID and a password, and the entered information is communicated to an authentication program in the server 130 or other suitable location.

In a decision block S203, if the user inputs a proper user ID and a corresponding proper password in the user authentication screen or dialog box, then the user is authenticated to access the system and the procedure advances to an operation block S204. If, however the user does not input a proper combination of user ID and password in the user authentication screen or dialog box, then the user is not authenticated to access the system, and the procedure returns to the decision block S203 to allow the user to attempt to enter a proper user ID and corresponding password.

In the operation block S204, the user is authenticated and the procedure advances to an operation block S205.

In the operation block S205, an initial page of the sales site (e.g., a home page) is displayed. For example, the home page advantageously illustrates various information relating to watercraft sales including, for example, specific business practices, watercraft selling prices, a purchasing menu, and performance values of different watercraft part combinations. Other sales information or general information pertaining to watercraft are also advantageously available for viewing on the home page.

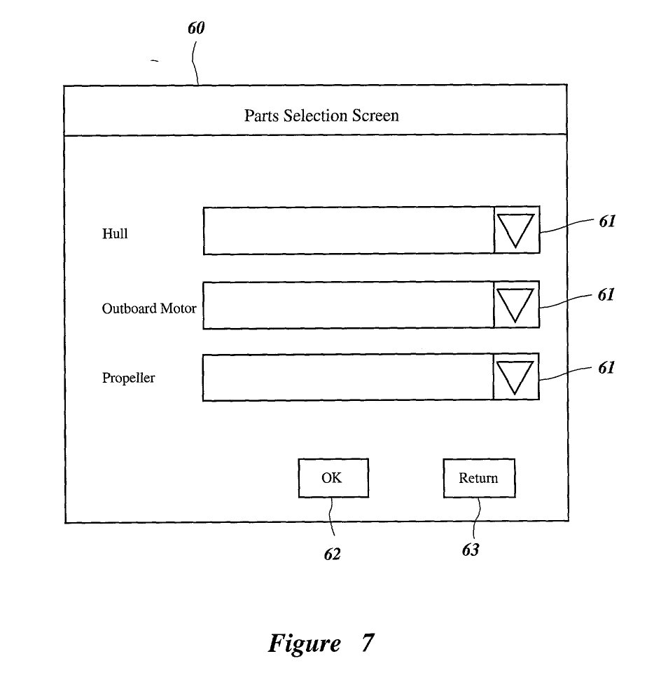

After displaying the home page, the procedure advances to a decision block S206, wherein the procedure determines whether a part combination confirmation button is activated by the user in the home page. If the button is activated, the procedure advances to an operation block S207 wherein a parts selection screen 60 shown in FIG. 7 is displayed. However, if the procedure determines in the decision block S206 that a part combination confirmation button is not activated in the home page, then the procedure returns to the decision block S206.

The parts selection screen 60 displays input boxes 61 for the selection of respective parts, such as a hull, an outboard motor and a propeller, as well as an OK button 62 and a return button 63. If one or more input boxes 61 are filled in with part numbers, part descriptions or both, or if part numbers, part descriptions or both are selected with pull down menus, then the OK button 62 on the parts selection screen 60 becomes active.

When the OK button 62 is activated, the procedure advances to a decision block S208 wherein the procedure determines whether the activated OK button is pressed by the user. If, in decision block S208, the OK button is pressed, then the procedure advances to an operation block S209. If, however, in the decision block S208, the OK button is not pressed, then the procedure returns to the decision block S208 to wait for the OK button to be pressed.

In the operation block S209, the boat performance managing software searches the database for applicable watercraft component performance combinations. The procedure then moves to an operation block S210 where the applicable watercraft component performance data is displayed.

In the operation block S209, if an absence of any corresponding combination of watercraft components occurs, then the closest combination of watercraft component performance data is displayed in operation block S210.

After completing the operation block S210, the procedure ends.

The above-described procedure displays performance data to provide a person wanting to purchase a boat with knowledge of the actual watercraft component performance data of a combination of parts that the user selects. If, after viewing the watercraft component performance data for a combination of parts, the user decides to purchase a watercraft the user returns to the top page of the sales site and purchases the watercraft having the desired combination of parts.

According to the embodiment of the small boat information providing system as described above, a customer who purchased a watercraft is requested to disclose the performance of the watercraft. This information is obtained at the network station (i.e., sales site) operated by a dealer or a watercraft manufacturer through a wired or wireless communication network. At the sales site where the performance data of the watercraft is disclosed, persons wanting to purchase watercraft and rating agencies can access the site, check various watercraft performance component combinations and confirm the actual performance previously sold watercraft having the selected component combinations.

As a further example, a rating agency is enabled to rate a used watercraft based on its actual performance data and is able to set an appropriate market price for the used watercraft based on an assigned rating.

As another example, when a dealer receives a used watercraft as a trade-in from a customer, the dealer can adjust the price to match the performance of the used watercraft because the dealer has access to the latest performance data from the customer for the specific used watercraft. Accordingly, a person wanting to purchase a new or used watercraft is able to research the various performance component possibilities and purchase a watercraft comfortably.

Although in the preferred embodiment the network station and the sales site are described as the same, they may be operated separately.

The software (boat performance managing software and web server software) for the server 130, the information collecting software for the information terminal 13, the control program for ECU 3, or the like may be stored in a computer readable storing medium, such as a flexible disk, or may be transmitted as a single software. In the preferred embodiment, a computer can process the software stored in a memory or download the software from a site (e.g., from a server) on a LAN or on the Internet to install the software.

The computer, such as the server 130 or the information terminal 13, functions to implement the processes based on the program stored in its memory medium. The server can be a single computer or the server may be a system that comprises a plurality of devices connected in a network.

The computer as used herein is a generic term of the device and apparatus capable of realizing the function of this invention, including not only a personal computer but also an operation processing unit and a microcomputer or the like.

According to the invention as described herein, the performance data of watercraft can be automatically obtained and compiled. The compiled data can be advantageously transmitted to a server computer for access on the Internet to predetermined users. Users wanting to purchase watercraft are able to confirm the actual performance of a selected watercraft component combination.

Although the present invention has been described in terms of a certain preferred embodiments, other embodiments apparent to those of ordinary skill in the art also are within the scope of this invention. Thus, various changes and modifications may be made without departing from the spirit and scope of the invention. For instance, various steps within the routines may be combined, separated, or reordered. In addition, some of the indicators sensed (e.g., engine speed and throttle position) to determine certain operating conditions (e.g., rapid deceleration) can be replaced by other indicators of the same or similar operating conditions. Moreover, not all of the features, aspects and advantages are necessarily required to practice the present invention. Accordingly, the scope of the present invention is intended to be defined only by the claims that follow.

What is claimed is:

1. A watercraft information sharing system comprising:
a data collection system that collects watercraft performance information for operational watercraft having combinations of components; and
a server that displays selected watercraft performance information in response to an inquiry from a user for information for a selected combination of components.

2. The watercraft information sharing system as defined in claim 1, wherein the watercraft performance information is collected via a communications network.

3. The watercraft information sharing system as defined in claim 1, wherein said communication network is a wireless communication network.

4. A watercraft comprising:
a hull, an engine and a propulsion device;
sensors that detect watercraft operation parameters when the engine and propulsion device are operated to propel the hull;
a data collection and storage system on the watercraft that that compiles and stores the watercraft operation parameters, and
an information terminal in communication with the data collection and storage system to selectively provide the watercraft operation parameters to a user and to selectively communicate the watercraft operation parameters to a remote location via a communications system.

5. The watercraft as defined in claim 4, wherein the watercraft sensors include a throttle opening sensor.

6. The watercraft as defined in claim 4, wherein the watercraft sensors include a shift position sensor.

7. The watercraft as defined in claim 4, wherein the watercraft sensors include an engine speed sensor.

8. The watercraft as defined in claim 4, wherein the watercraft sensors include a fuel sensor.

9. The watercraft as defined in claim 4, wherein the watercraft sensors include a hull speed sensor.

10. A computer system comprising:
a server that collects performance data from a plurality of watercraft and that stores the collected performance data in association with installed component information for the plurality of watercraft; and
a server access device to provide the server with a selected combination of components and to receive performance data from the server, the received performance data being selected by the server from the stored performance data for watercraft having installed components corresponding to the selected combination of components.

11. A watercraft information sharing system, comprising:
a plurality of watercraft, each watercraft comprising:
a hull, an engine and a propulsion device;
sensors that detect watercraft operation parameters when the engine and propulsion device are operated to propel the hull;
a data collection and storage system on the watercraft that that compiles and stores the watercraft operation parameters, and
an information terminal in communication with the data collection and storage system to selectively communicate the watercraft operation parameters to a remote location via a communications system; and
a computer system at the remote location that receives the watercraft operation parameters from the plurality of watercraft, the computer system storing the operation parameters for each watercraft in association with information regarding components installed on each watercraft, the computer system responsive to inquiries to disclose operation parameters for selected combinations of installed components.

12. A method for sharing watercraft performance data with a plurality of users, the method comprising:
collecting performance data from a plurality of watercraft;
storing the collected performance data in association with installed component information for the plurality of watercraft;
receiving an inquiry for performance data for a watercraft having a selected combination of components; and
providing collected performance data from watercraft having the selected combination of components.

13. A method for providing performance data for a watercraft, comprising:
storing information identifying the parts installed on a plurality of watercraft in a data storage device of a computer system;
storing collected performance data received from the plurality of watercraft in the data storage device in association with the watercraft;
prompting a user to enter a selected combination of components to be installed on a watercraft;
retrieving stored performance data for watercraft having the selected combination of installed components; and
providing the retrieved performance data to the user.
